(19) United States
(12) Patent Application Publication
(10) Pub. No.: US 2025/0293439 A1
(43) Pub. Date: Sep. 18, 2025

(54) Integration-Friendly Low-Profile Planar Grin Lens Antennas for Millimeter Wave Handheld Devices

(71) Applicant: University of Notre Dame du Lac, South Bend, IN (US)

(72) Inventors: Nicolas Garcia, South Bend, IN (US); Jonathan Chisum, South Bend, IN (US)

(21) Appl. No.: 18/862,753

(22) PCT Filed: May 3, 2023
(86) PCT No.: PCT/US2023/066551

§ 371 Date: Nov. 4, 2024

Related U.S. Application Data
(60) Provisional application No. 63/364,091, filed on May 3, 2022.

(51) Int. Cl. H01Q 19/06; H01Q 1/22; H01Q 21/28

(52) U.S. Cl. CPC H01Q 19/062; H01Q 1/22; H01Q 21/28

(57) ABSTRACT

A mobile computing device includes a plurality of antennas. Each one of the plurality of antennas includes an antenna feed element. The mobile computing device includes a reflector or lens comprising at least one gradient-index (GRIN) lens, wherein the reflector or lens is further configured to focus a first signal generated by the antenna feed element and focus a second signal not generated by the antenna feed element onto the antenna feed element.

### CROSS REFERENCE TO RELATED APPLICATIONS

This application is a National Stage of International Application No. PCT/US23/66551 filed on May 3, 2023, and entitled “INTEGRATION-FRIENDLY LOW-PROFILE PLANAR GRIN LENS ANTENNAS FOR MILLIMETER WAVE HANDHELD DEVICES”, which claims priority to U.S. Provisional Application No. 63/364,091 filed on May 3, 2022, and entitled “INTEGRATION-FRIENDLY LOW-PROFILE PLANAR GRIN LENS ANTENNAS FOR MILLIMETER WAVE HANDHELD DEVICES”, each of which are herein incorporated by reference in their entirety.

This application is related to U.S. patent application Ser. No. 17/721,898 filed on Apr. 15, 2022, and entitled “LENS ANTENNA SYSTEMS AND METHODS” and U.S. patent application Ser. No. 17/725,547 filed on Apr. 21, 2022, and entitled “SPARSE PHASED-ARRAY-FED FOCUSING APERTURE ANTENNAS WITH REDUCED GRATING LOBES”, each of which are hereby incorporated by reference in their entirety.

### STATEMENT REGARDING FEDERALLY SPONSORED RESEARCH OR DEVELOPMENT

This invention was made with government support under N00014-20-C-1067 awarded by the Office of Naval Research (ONR) and N00173-16-D-2009 awarded by the U.S. Naval Research Laboratory (NRL). The government has certain rights in the invention.

### BACKGROUND

Beam-scanning gradient-index (GRIN) lenses are quickly becoming a viable technology in the 5G and MMW communications applications spaces due to their low-power beamforming capabilities. However, the common switched-feed beamforming approach tends to result in undesirable scan loss for high scan angles. This is ultimately because the easiest and most straightforward feeding scheme—wherein the feeds are uniformly oriented and placed on a flat focal plane—is generally different from the most effective feeding scheme wherein feeds are placed on a curved surface beneath the lens and oriented individually toward the lens. Feeds in the former case generate worse collimation due to their displacement from the Petzval surface and suffer from high spillover loss due to uniform orientation. These non-idealities manifest in the far field as beam-widening, coma lobe, and reduced gain.

Lens antennas typically achieve beam scan by switching between various feed elements distributed across a focal plane below the lens. However, excessive scan-loss occurs toward the edges of the lens (corresponding to extreme scan angles). This is caused by significant spillover from feeds near the edge of the lens and from aperture phase distortion due to imperfect phase collimation. These issues are exacerbated if feed elements must lie in a flat plane differing from the optimal Petzval focal surface.

The present disclosure recognizes that is desirable then to synthesize GRIN systems that intrinsically address the flat-feeding handicap.

### BRIEF DESCRIPTION OF THE DRAWINGS

FIG. 1A illustrates an example mobile electronic device having a plurality of antennas in accordance with embodiments of the present disclosure.

FIG. 1B illustrates an example system of a mobile electronic device where an antenna is in communication with a controller or processor of the mobile electronic device in accordance with embodiments of the present disclosure.

FIG. 2 is a perspective view of a compound GRIN lens fanbeam antenna in accordance with an embodiment of the present disclosure.

FIG. 3A is a cross-sectional view of a lens antenna in accordance with an embodiment of the present disclosure.

FIG. 3B is a cross-sectional view of a lens antenna in accordance with another embodiment of the present disclosure.

FIG. 4 illustrates a folded parallel plate configuration shown in FIG. 2 utilizing a 90° waveguide bend to reduce the on-axis depth of the antenna.

FIG. 5 illustrates permittivity profiles of the aperture lens and the focal lens.

FIGS. 6A and 6B illustrate farfield gain patterns for 30 GHz and 40 GHz respectively.

FIG. 6C illustrates peak gain values over angle and frequency for lens antenna systems shown in FIGS. 1A, 1B, and 4.

FIG. 7 illustrates a compound lens antenna system for use with a linear feed array in accordance with embodiments of the present disclosure.

FIG. 8A shows full wave electromagnetic simulations (using Ansys HFSS) of both beam angles with and without feed correction focal lenslets (labeled “w/lenslet” and “w/o lenslet”, respectively) at 40 GHz.

FIG. 8B shows a gain at 40 GHz in a φ=0 plane from θ=−90° to +90° for each beam angle with and without an FCL.

FIG. 8C shows gain over beam scan with the feed correction focal lenslet (top plot) and gain summary with scan loss exponents of 2 and 3 (bottom plot).

FIG. 9 is a diagrammatic view of an example embodiment of a computing environment in accordance with embodiments of the present disclosure.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DETAILED DESCRIPTION

The following description of example methods and apparatus is not intended to limit the scope of the description to the precise form or forms detailed herein. Instead, the following description is intended to be illustrative so that others may follow its teachings.

Described herein are small, flat gradient-index (GRIN) lens antennas that may be integrated with millimeter wave (MMW) handheld devices such that the antennas themselves lay flush against the device surface or on the inside of a case or shell of the device, with a radiating aperture of the antenna being is co-located with or near an edge of the device. Such low-profile devices may be a relatively low cost and low power alternative to conventional MMW handheld device antennas.

The lens antennas may be formed in a compact (e.g., less than 0.5 millimeters (mm) thick) planar parallel plate waveguide structure in an industry-standard MMW printed circuit board (PCB) material. The lens antennas may each have one-dimensional beam-scan over, for example, a +/−50 degree field of view such that four antennas may provide 360 degree coverage (with some overlap) when placed along four edges of a flat handheld device. The beams may be sufficiently broad in the in-plane direction that total or near-total spherical radiation coverage is therefore provided for the handheld device.

The embodiments herein may therefore provide full or near-full spherical coverage for MMW radio on a handheld device. In various embodiments, such coverage for MMW radio may be provided without the use of phased array technology. Specifically, this approach would require lower power and fewer costly MMW components while still being extremely low profile and easy to integrate with conventional MMW circuit technology. Such embodiments may also be useful for 5^{th} or 6^{th} generation (5G or 6G) wireless communication technologies.

Various mobile electronic devices, such as handheld devices like smart phones, tablets, laptops, virtual reality (VR) headsets, portable game consoles or controllers, etc., may have at least one flat side or dimension. As such, lens antennas as described herein, which may generally have a planar shape with minimal (e.g., less than 0.5 mm) thickness may be added to the flat or planar sides of mobile electronic devices. They may be added on the outside or inside surface of the device, may be integrated into a surface of the device, etc. as desired. In other words, the surfaces of the mobile electronic device may be planar and therefore may easily incorporate or include a planar antenna on or in its flat surfaces. In various embodiments, the antennas described herein may be placed anywhere on a flat surface of the mobile electronic device and radiation from or to those antennas may be engineered to emerge and/or enter roughly normal to that surface. However, various planar lens antennas as described herein may only scan beams along one dimension. As such, in some embodiments, a mobile electronic device may include multiple (e.g., four) lens antennas, one at each of the four edges of a device. In various embodiments, the mobile electronic device may also have more or less than 4 antennas.

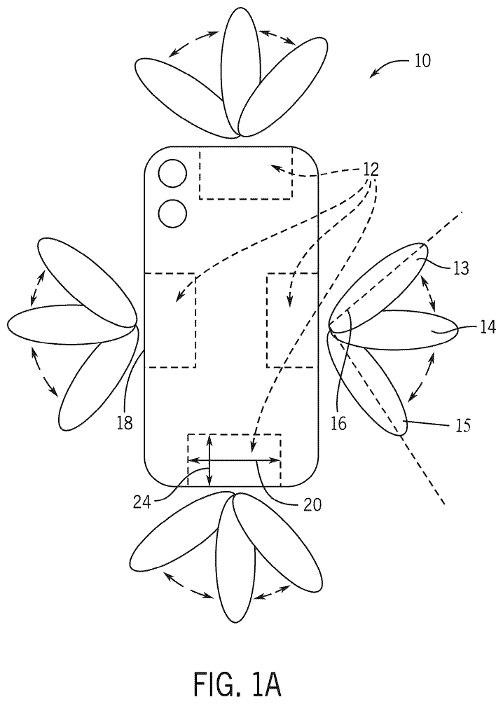

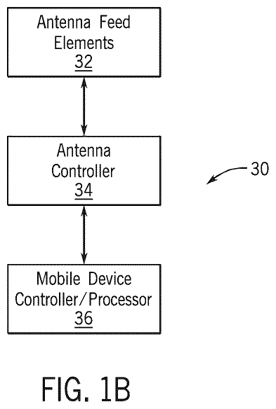

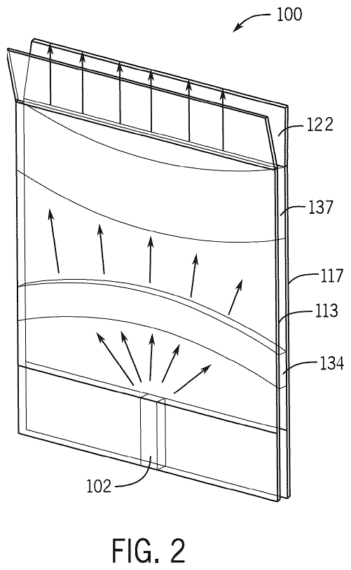

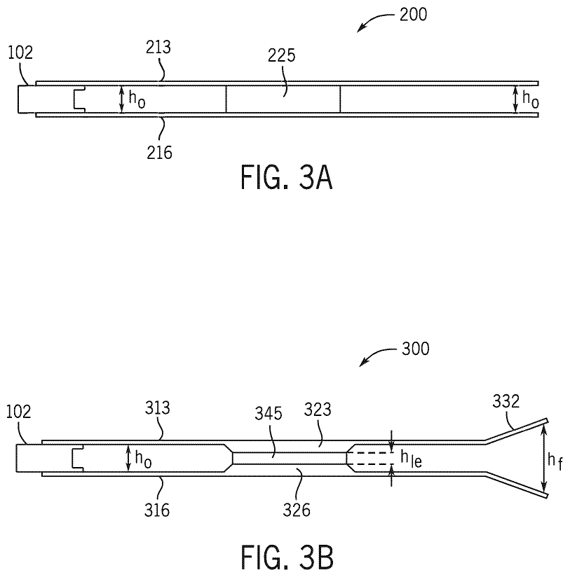

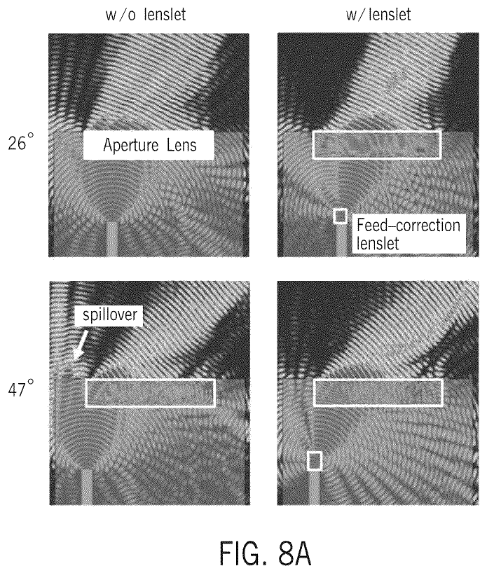

FIG. 1A illustrates an example of an electronic device such as a mobile computing device 10 having a plurality of antennas 12 in accordance with embodiments of the present disclosure. Each of the antennas 12 may be for example, the antennas 100, 200, 300, 400, etc. shown in and described with respect to FIGS. 2, 3A, 3B, and/or FIG. 7, in various embodiments. As shown in FIG. 1A, the antennas 12 may be placed around the edges of the mobile computing device 10, in this case a smart phone, so that an edge of each of the antennas 12 aligns with an edge of the mobile computing device 10.

As depicted in FIG. 1A, the antennas 12 may each have one-dimensional beam-scan over, for example, a +/−50 degree field of view such that four antennas may provide 360 degree coverage (with some overlap) when placed along the four edges (e.g., edge 18) the mobile computing device 10. For example, beams 13, 14, 15 show example beams of an antenna 12 over an angled range 16. The beam 14 may be at the 0 degree position, the beam 13 may be at +50 degrees, and the beam 15 may be at −50 degrees, giving each of the antennas 12 a total of 100 degrees of beam-scan. In various embodiments, antennas as described herein may be configured to have anywhere between +/−0 degrees field of view to +/−65 degrees field of view, including for example any of +/−0 degrees field of view, +/−5 degrees field of view, +/−10 degrees field of view, +/−15 degrees field of view, +/−20 degrees field of view, +/−25 degrees field of view, +/−30 degrees field of view, +/−35 degrees field of view, +/−40 degrees field of view, +/−45 degrees field of view, +/−50 degrees field of view, +/−55 degrees field of view, +/−60 degrees field of view, and/or +/−65 degrees field of view.

The antennas 12 may also have a height 24, a length 20, and a width not shown that is significantly less than the height 24 and the length 20. In this way, the antennas 12 may form a planar structure so as to integrate with or be placed on a mobile electronic device without significantly increasing or changing the size of the mobile electronic device. The width of the antennas may be, for example, anywhere from 0.1 millimeters (mm) to 2 mm in width, including example widths such as 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 1 mm, 1.25 mm, 1.5 mm, 1.75 mm, and/or 2 mm.

As such, FIG. 1A shows a mobile computing device 10 that may include a plurality of the antennas 12. Each one of the plurality of antennas 12 may include at least one antenna feed element and a reflector or lens as described further herein. The reflector or lens may be or may include at least one gradient-index (GRIN) lens. Such a GRIN lens may be configured to focus a first signal generated by the antenna feed element and focus a second signal not generated by the antenna feed element onto the antenna feed element. Examples of such antennas with GRIN lenses are further shown in and discussed with respect to FIGS. 2, 3A, 3B, and/or FIG. 7, in various embodiments.

The mobile computing device 10 may be a smart phone, a virtual reality headset, a tablet computing device, a portable gaming console, a laptop computing device, or any other kind of portable or handheld electronic device. In various embodiments, the antennas described herein may also be implemented on electronic devices that are designed to be stationary, are not handheld, etc.

In the example, of FIG. 1A, the mobile computing device 10 has four antennas. However, in various other embodiments, a device may have 1, 2, 3, 5, 6, 7, 8, 9, 10, 11, 12, 13, 14, 15, 16, 17, 18, 19, 20, or more antennas as desired.

The mobile computing device 10 further includes a radiating aperture at the edge of each antenna 12 that aligns with a first edge or surface of the mobile computing device 10, such as at the edge 18 in FIG. 1A. For example, an outlet 332 of FIG. 3B or an outlet 122 of FIG. 2 may be a the radiation aperture of each antenna 12. A radiating aperture may be a flared or non-flared outlet of the antenna 12.

As such, the radiating apertures of different antennas at the edges of surfaces of the mobile computing device 10 may be normal or parallel to one another (e.g., the antennas on opposing sides of the mobile computing device 10 have parallel radiating apertures while the antennas on adjacent edges have radiating apertures that are normal or perpendicular to one another). Depending on a shape of the mobile computing device 10, antennas 12 may have different orientations with respect to one another while still having their radiating apertures fixed along an edge. As described herein, each of the plurality of antennas 12 may be shaped as a planar plate and mounted within a same plane on the mobile computing device 10 so that advantageous coverage around the mobile computing device 10 may be achieved.

As shown and described further in FIG. 2, an antenna may have more than one lens or reflector, such as the GRIN lenses (e.g., focal lens 134 and aperture lens 137), where the GRIN lenses are positioned in series such that signals emitted from a signal feed element 102 pass from a first GRIN lens (e.g., focal lens 134) to a second GRIN lens (e.g., aperture lens 137), and so that received signals pass from the second GRIN lens (e.g., aperture lens 137) to the first GRIN lens (e.g., focal lens 134), and then onto the signal feed element 102. As further described herein, the GRIN lenses may be disposed inside a channel formed by two parallel plates and configured to serve as a waveguide for electromagnetic radiation (e.g., incoming and outgoing signals). In various embodiments, the antennas 12 may also include a single feed element such as the antenna shown in FIG. 2 or may have multiple antenna feed elements such as the antenna shown in FIG. 7.

A method for using an antenna such as the antenna 12 of FIG. 1A may include focusing, with a reflector or lens of a mobile computing device, a first signal not generated by an antenna feed element of the mobile computing device onto the antenna feed element. The method may further include controlling, by a controller or processor of the mobile computing device, the antenna feed element to generate a representation of the first signal. The first signal may have a nominal wavelength. The method may further include controlling, by the controller or processor of the mobile computing device, the antenna feed element to generate a second signal. The method may further include focusing, with the reflector or lens, the second signal generated by the antenna feed element to emit the second signal. In various embodiments, the reflector or lens may be multiple GRIN lenses as described herein.

An example electromagnetic antenna of a mobile computing device may therefore include an antenna feed element configured to radiate a first signal, the first signal having a first frequency, a first amplitude, and a first phase. The electromagnetic antenna may further include a channel formed by two parallel plates spaced apart by a predetermined distance less than 1λ wherein λ is a wavelength of the first signal emitted by the electromagnetic antenna, the two parallel plates forming a channel serving as a waveguide for the electromagnetic radiation. The electromagnetic antenna may further include a planar focal surface on which the antenna feed element is mounted. The electromagnetic antenna may further include an electromagnetic lens configured to focus the first signal for transmission. The electromagnetic lens may be a compound lens having first and second lens elements arranged in series. The compound lens may focus the first signal, and each of the first and second lens elements may include a gradient-index (GRIN) lens. An end of the channel from which the first signal is emitted may include a radiating aperture of the electromagnetic antenna, wherein the radiating aperture is positioned along an edge of a surface of the mobile computing device.

FIG. 1B illustrates an example system 30 of a mobile electronic device where an antenna is in communication with a controller or processor 36 of the mobile electronic device in accordance with embodiments of the present disclosure. In other words, FIG. 1B shows how an antenna may be used in and communicate with aspects of a mobile electronic device. For example, an antenna feed element or elements 32 (depending on how many are used in a given antenna, or if multiple antennas are used) may be electrically connected to an antenna controller 34. In various embodiments, each antenna may be connected to its own antenna controller 34 or multiple antennas may be connected to an antenna controller 34. In either instance, the antenna controller 34 may further interface with and be electrically connected to the mobile electronic device's controller or processor 36. In this way, the controller/processor 36 of the mobile device may instruct the antenna controller 34 to output certain signals via the antenna feed element(s) 32, and the controller/processor 36 of the mobile device may receive signals captured by the antenna feed element(s) 32 as translated by the antenna controller 34.

The present disclosure further describes a compound GRIN lens system wherein two or more GRIN lenses are employed. The compound lens approach in general increases the degrees of freedom and is common in optical applications. Furthermore, by using only GRIN media in all lens components, the total weight and dielectric loss of the system can be minimized. Design and 3D fullwave simulation results of a two-lens GRIN antenna are disclosed hereinafter.

FIG. 2 is a perspective view of a compound GRIN lens fanbeam antenna 100 in accordance with an embodiment of the present disclosure. The antenna 100 includes two parallel plates 113 and 117 spaced apart by a predetermined distance as waveguides. As such waveguide turns a three-dimensional radiation pattern into a two-dimensional form, the predetermined distance is preferably less than 1λ, where λ is a wavelength of the radiative signal the antenna 100 is designed to operate. As an example, the antenna 100 has a width of 152.4 mm and a length 171 mm and the parallel plates 113 and 117 is spaced apart by 3.6 mm.

As shown in FIG. 2, an exemplary signal feed element 102 is sandwiched between the parallel plates 113 and 117 at a first end of the antenna 100. In practice, multiple feeds may be sandwiched between the parallel plates 113 and 117 to form a feed array with a uniform feed orientation.

As shown in FIG. 2, a focal lens 134 and an aperture lens 137 are also sandwiched between the parallel plates. The focal lens 134 is disposed in a middle of the antenna 100 as a first lens to modulate electromagnetic radiation from the signal feed element 102. The focal lens 134 has a first curved permittivity profile to provide squinting for offsetting feeds and flattening focal surface.

The aperture lens 137 is disposed near a second end of the antenna 100 opposite to the first end. The aperture lens 137 has a second curved permittivity profile to further modulate the electromagnetic radiation beams after the focal lens 134. The aperture lens 137 provides the bulk of phase collimation.

As shown in FIG. 2, the signal feed element 102 radiates uncollimated rays. The focal lens 134 turns the uncollimated rays into partially collimated rays (rays still spreading, but less so). Then the aperture lens 137 turn the partially collimated rays into fully collimated rays (traveling in a same direction).

As shown in FIG. 2, the antenna 100 includes an exemplary flared outlet 122 at the second end to amplify the signal. As an example, the flared outlet 122 has an opening of 15 mm expanded from a space of 3.6 mm.

FIG. 3A is a cross-sectional view of a lens antenna 200 in accordance with an embodiment of the present disclosure. The lens antenna 200 includes parallel plates 213 and 216 with a signal feed element 102 sandwiched therebetween at a first end of the lens antenna 200. The parallel plates 213 and 216 are spaced apart by h₀ uniformly throughout their entire length, where h₀ is exemplarily less than 1λ, and preferable less than 0.8λ. In an embodiment, the lens antenna 200 employs only one lens 225 disposed in the middle section of the parallel plates 213 and 216.

FIG. 3B is a cross-sectional view of a lens antenna 300 in accordance with another embodiment of the present disclosure. The lens antenna 300 includes parallel plates 313 and 316 spaced apart by a distance h₀. The lens antenna 300 has a narrowed middle section at a location of a lens 345. The narrowed middle section is formed by an upper member 323 protruding from the upper plate 313 and a lower member 326 protruding from the lower plate 316. In an embodiment, the upper member 323 and the lower member 326 are symmetrical and reduces the middle section to a space of hₗₑ. The lens antenna 300 exemplarily has a flared outlet 332 with an opening dimension of h_{f}, where hₗₑ<h₀<h_{f}.

In embodiments, the spacing of the parallel plates 313 and 316 near the antenna aperture progressively increases to enhance the antenna gain. The spacing of the parallel plates 313 and 316 can also be locally increased near feed plane to accommodate larger or wideband feeds by strategically reducing the spacing in other sections, such the middle section of the antenna 300 as shown in FIG. 3B.

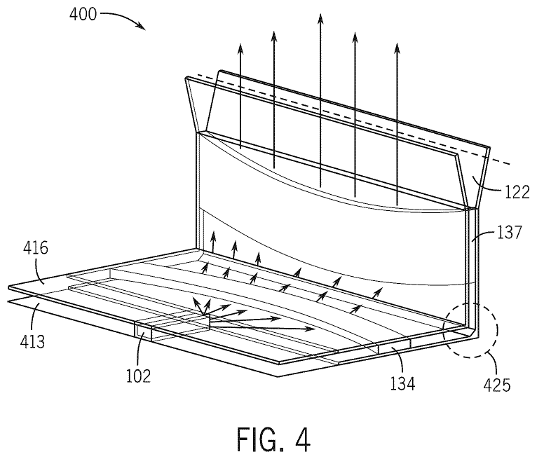

FIG. 4 illustrates a folded parallel plate configuration shown in FIG. 2 utilizing a 90° waveguide bend to reduce the on-axis depth of the antenna 400. Parallel plates 413 and 416 have an exemplary 90° bend at a location 425 between the focal lens 134 and the aperture lens 137. Due to the narrow space between the parallel plates 413 and 416 turns a three-dimensional waveform into a two-dimensional one, at least a transverse electromagnetic (TEM) mode radiation propagates through the bend unimpeded. In other embodiments, the parallel plates 413 and 416 can form a bend of any desired angle. The parallel plates can also be nested with other plates by properly bending more than one of the parallel plate antennas. It is also possible to include multiple bends, allowing for significant space savings by folding the feed upon itself.

In an embodiment, the parallel plates are spaced 3.6 mm apart such that only the desired transverse electromagnetic (TEM) mode propagates across the entire WR-28 band. The lens is fed with a WR-28 open ended waveguide (OEWG) and the feed is translated laterally along a flat focal line to achieve a beam scan. The parallel plate structure is exemplarily flared to 15 mm wide at the aperture in order to increase gain and reduce impedance mismatch at a freespace boundary. In the case of the folded parallel plate waveguide, a 45° mitered corner with a gap size of 3.2 mm provides a wideband 90° transition.

Both parallel plate and folded parallel plate configurations are simulated in Empire XPU 3D full-wave FDTD software over 26-40 GHz.

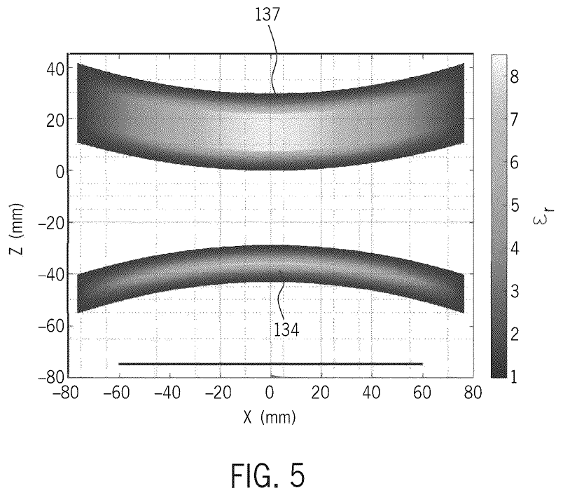

FIG. 5 illustrates permittivity profiles of the aperture lens and the focal lens. The GRIN lens permittivity distributions are nominally based on a taper-core-taper design flow, and optimized using a 2D finite difference time domain (FDTD) solver. To maximize design freedom, the lens' core permittivity profiles and surfaces are optimized for peak gain over angle. In an embodiment, both lenses are 152.4 mm wide. The ‘aperture’ lens (at the aperture of the antenna) provides the bulk of the beam-shaping while the ‘focal’ lens (near the feed plane) provides beam-squinting for offset feeds while flattening the focal surface. The ‘focal’ lens is preferably disposed close to the feed plane in order to intercept feed radiation before it is lost to spillover. As an example, the focal lens 134 is substantially thinner than the aperture lens 137 due to its comparatively small contribution to the total collimation. As shown in FIG. 5, the focal lens 134 is approximately 12 mm thick while the aperture lens 137 is approximately 30 mm thick.

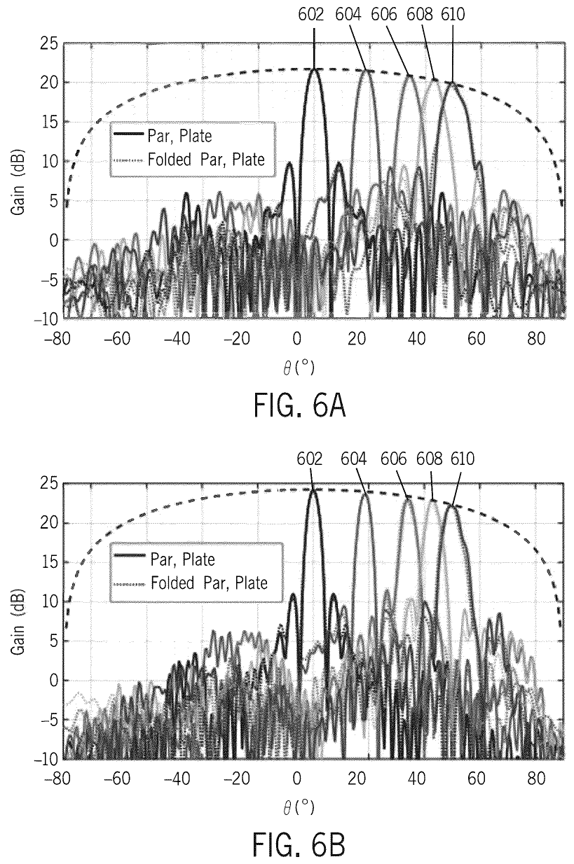

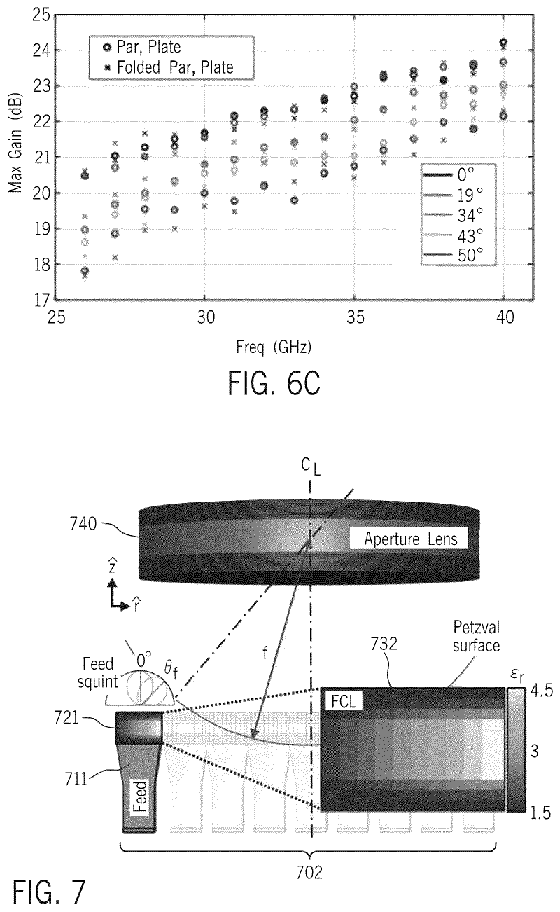

FIGS. 6A and 6B illustrate farfield gain patterns for 30 GHz and 40 GHz, respectively, with parallel plate results plotted solid lines and folded parallel plate results plotted dotted lines. Beam peaks are located at 0° (line 602), 19° (line 604), 34° (line 606), 43° (line 608), and 50° (line 610). The parallel plate and folded parallel plate results agree extremely well, validating the profile-reduction method. For both lens configurations the beam-shape is maintained out to 50° with scan loss near 2 dB at both frequencies. For reference, a cos¹(θ) scan loss envelope is provided in a dashed black trace. The beamscan results track this envelope reasonably well indicating that the compound GRIN lens system is achieving roughly the same degree of beam performance for all θ<±50°.

FIG. 6C illustrates peak gain values over angle and frequency for the planer parallel plates 113 and 117 (represented by circle markers) and folded parallel plates 413 and 416 (represented by x markers) systems. The scan loss trends are consistent across the Ka-band for both configurations. The worst case scan loss envelope of cos^{1.4}(θ) (2.7 dB at 50°) occurs at 26 GHz. Otherwise, the average maximum scan loss is 2 dB yielding a wideband scan loss envelope of cos^{1.1}(θ). These results indicate that compound GRIN lens systems with simple feeding schemes have potential for high performance beamscan applications.

In order to significantly improve beamscan performance of lens antennas, a compound antenna system comprising an aperture lens and a focal lens serving as a feed-correction lenses (FCL) at every feed element is disclosed. The FCL is uniquely designed for each feed location in order to: i) squint the feed beam toward the center of the lens to reduce spillover, and ii) predistort the feed phase in order to correct aperture phase distortion and improve efficiency and gives rise to sidelobes (e.g., coma lobe).

FIG. 7 illustrates a compound lens antenna system for use with a linear feed array 702 in accordance with embodiments of the present disclosure. The linear feed array 702 is constrained to a constant z\hat{ }-plane below the aperture lens at z=f, where f is the focal distance for only the central feed element. In addition, off-center feeds 711 are prohibited from tilting toward the center of the aperture lens. These constraints result in increased spillover loss and aperture phase distortion, which increases scan loss and degrades the quality of the radiation pattern.

While multiple-focus aperture lenses can be designed such as the Rotman lens and other constrained lenses, they require feeds to be placed on specific non-planar surfaces and they are practically limited to 3 or 4 focal points. Since the FCL design decouples the feed correction from the aperture lens the lens system can be simultaneously optimized for every scan angle. The present disclosure describes a reduction of spillover loss in which an FCL is designed for each feed location to squint the feed beam to an angle θ_{f}, toward the center of the lens. A correction of aperture phase distortion with the FCLs is also possible.

As shown in FIG. 7, an exemplary 4″ fanbeam aperture lens 740 with modest beam-scan capability is designed and simulated. A linear feed array 702 comprising 10 dBi horn antennas is constrained to a plane a distance fbelow the aperture lens center. A FCL 721 for a modest scan angle (27°) and extreme scan angle (49°) is designed. A cross-section view 732 of the FCL design shows that the permittivity ranges from 1.5 to 4.5. The FCL 721 includes a broadband matching layer on top and bottom to provide high performance across the WR28 band from 26.5 GHz to 40 GHz.

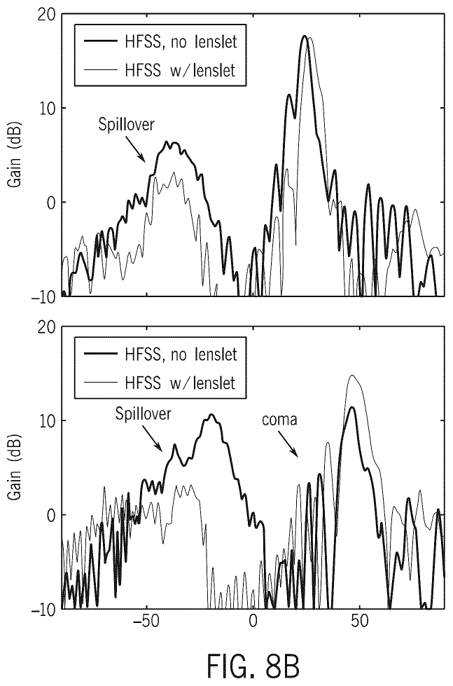

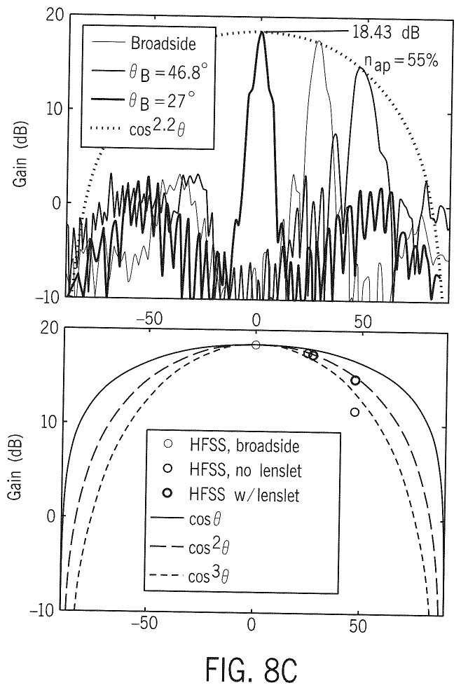

FIG. 8A shows full wave electromagnetic simulations (using Ansys HFSS) of both beam angles with and without feed correction focal lenslets (labeled “w/lenslet” and “w/o lenslet”, respectively) at 40 GHz. The top and bottom rows correspond to the 27° and 47° beams, respectively.

FIG. 8B shows a gain at 40 GHz in a φ=0 plane from θ=−90° to +90° for each beam angle with and without an FCL. For angles θ<0°, there is a significant rise in gain at undesired angles as a result of feed power spilling over the left side of the aperture lens. The spillover is more pronounced for the feed closest to the edge and corresponds to a beam angle of 47°. With the FCL present the power is squinted in toward the center of the lens and the spillover is reduced significantly. In the case of the 27° beam the spillover reduces from about 6.3 dB to 3.2 dB. For the 47° beam the spillover reduces from about 10.6 dB to 3.2 dB (reduced by more than 7 dB). For θ>90° it is notable that the coma distortion is significant for the 47° beam with the FCL present. As stated above, aperture phase distortion is not corrected with this FCL. The scanned beam at 27° has nearly identical gain in each case (17.5 dB) which is expected because spillover loss was already low without an FCL but the beam angle was shifted by a few degrees. The gain of the 47° beam increased from 11.5 dB to 14.8 dB, or by 3.3 dB. The calculated spillover efficiency of the squinted feed beam was 48.9% without an FCL and 81% with an FCL, which accounts for a 2.2 dB increase in gain from just spillover improvement. The additional 1.1 dB is due to incidental phase correction across the lens aperture (despite their being pronounced coma distortion).

FIG. 8C shows gain over beam scan with the feed correction focal lenslet (top plot) and gain summary with scan loss exponents of 2 and 3 (bottom plot), which summarizes overall performance of the FCL design. As shown in FIG. 8C, broadside gain as well as the two beam scan angles (27° and 47°) are shown together with a scan loss curve of cos^{2.2}θ. On the bottom half of the figure the main beam gain with (blue marker) and without (red marker) FCLs are included and show that the FCL has a dramatic reduction in scan loss at extreme angles. A best fit of cosⁿθ was found for patterns with and without FCLs and it was found that a scan loss exponent of 3.0 fit the patterns without an FCL while a scan loss exponent of 2.0 fit the patterns with an FCL.

The present disclosure demonstrates through full-wave electromagnetic simulation that the FCL design can dramatically reduce scan loss over extreme beam scan angles. In embodiments, incorporating phase predistortion in the FCL can further improve scan loss and correct aperture phase distortions which cause coma distortion and other undesirable significant sidelobes.

Although certain example methods, apparatuses, and computer readable media have been described herein, the scope of coverage of this patent is not limited thereto. On the contrary, this patent covers all methods, apparatus, computer readable media, and articles of manufacture fairly falling within the scope of the appended claims either literally or under the doctrine of equivalents.

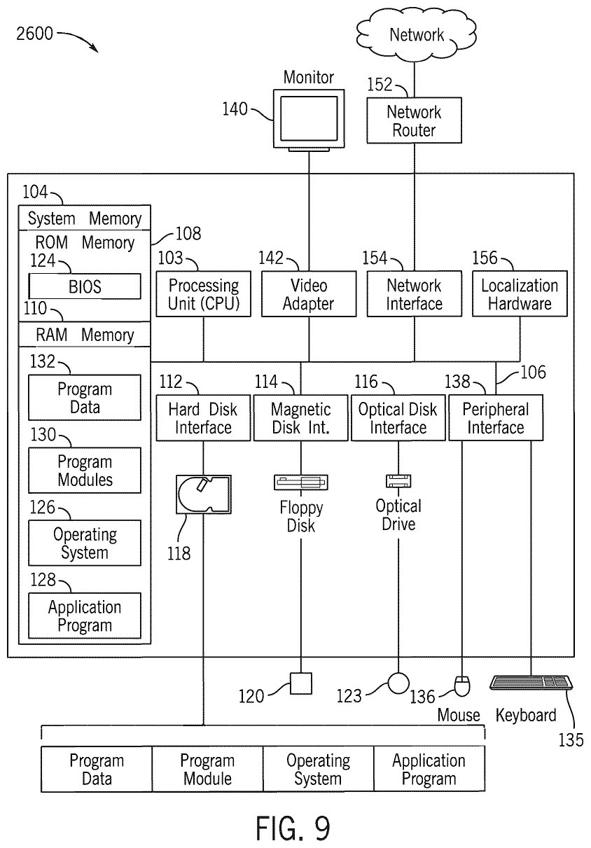

FIG. 9 is a diagrammatic view of an example embodiment of a computing environment that includes a general-purpose computing system 2600, such as a desktop computer, laptop, smartphone, tablet, or any other such device having the ability to execute instructions, such as those stored within a non-transient, computer-readable medium. Any of the methods or systems described herein may be implemented on or executed by instructions stored upon a computing system 2600 that has any combination of the components shown in and described with respect to FIG. 9. For example, a controller or processor of a computing system 2600 may generate signals for transmission through various GRIN lens antennas as described herein and/or may receive and process signals that are received through the GRIN lens antennas described herein. Similarly, computing systems 2600 may include instructions stored on memory and executable by a processor to carry out any of the methods for using the embodiments described herein.

Furthermore, while described and illustrated in the context of a single computing system 2600, those skilled in the art will also appreciate that the various tasks described herein may be practiced in a distributed environment having multiple computing systems 2600 linked via a local or wide-area network in which the executable instructions may be associated with and/or executed by one or more of multiple computing systems 2600.

In its most basic configuration, computing system 2600 typically includes at least one processing unit 103 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system 2600 may have additional features and/or functionality. For example, computing system 2600 may also include additional storage (removable and/or non-removable) including, but not limited to, magnetic or optical disks, tape drives and/or flash drives. Such additional memory devices may be made accessible to the computing system 2600 by means of, for example, a hard disk drive interface 112, a magnetic disk drive interface 114, and/or an optical disk drive interface 116. As will be understood, these devices, which would be linked to the system bus 106, respectively, allow for reading from and writing to a hard drive 118, reading from or writing to a removable magnetic disk 120, and/or for reading from or writing to a removable optical disk 123, such as a CD/DVD ROM or other optical media. The drive interfaces and their associated computer-readable media allow for the nonvolatile storage of computer readable instructions, data structures, program modules and other data for the computing system 2600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system 2600.

A number of program modules may be stored in one or more of the memory/media devices. For example, a basic input/output system (BIOS) 124, containing the basic routines that help to transfer information between elements within the computing system 2600, such as during start-up, may be stored in ROM 108. Similarly, RAM 110, hard drive 118, and/or peripheral memory devices may be used to store computer executable instructions comprising an operating system 126, one or more applications programs 128 (which may include the functionality disclosed herein, for example), other program modules 130, and/or program data 132. Still further, computer-executable instructions may be downloaded to the computing system 2600 as needed, for example, via a network connection.

An end-user may enter commands and information into the computing system 2600 through input devices such as a keyboard 135 and/or a pointing device 136. While not illustrated, other input devices may include a microphone, a joystick, a game pad, a scanner, etc. These and other input devices would typically be connected to the processing unit 103 by means of a peripheral interface 138 which, in turn, would be coupled to bus 106. Input devices may be directly or indirectly connected to processor 103 via interfaces such as, for example, a parallel port, game port, firewire, or a universal serial bus (USB). To view information from the computing system 2600, a monitor 140 or other type of display device may also be connected to bus 106 via an interface, such as via video adapter. In addition to the monitor 140, the computing system 2600 may also include other peripheral output devices, not shown, such as speakers and printers.

The computing system 2600 may also utilize logical connections to one or more computing systems. Communications between the computing system 2600 and the remote computing system environment may be exchanged via a further processing device, such as a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system 2600, or portions thereof, may be stored in the memory storage device(s) of the computing system 2600.

The computing system 2600 may also include localization hardware 186 for determining a location of the computing system 2600. In embodiments, the localization hardware 156 may include, for example only, a GPS antenna, an RFID chip or reader, a WiFi antenna, or other computing hardware that may be used to capture or transmit signals that may be used to determine the location of the computing system 2600.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A mobile computing device comprising:
a plurality of antennas, wherein each one of the plurality of antennas comprises:
an antenna feed element; and
a reflector or lens comprising at least one gradient-index (GRIN) lens, wherein the reflector or lens is further configured to focus a first signal generated by the antenna feed element and focus a second signal not generated by the antenna feed element onto the antenna feed element.

2. The mobile computing device of claim 1, wherein the mobile computing device is a smart phone, a virtual reality headset, a tablet computing device, a portable gaming console, or a laptop computing device.

3. The mobile computing device of claim 1, wherein the plurality of antennas comprises at least a first antenna and a second antenna, the first antenna has a first radiating aperture, and the second antenna has a second radiating aperture.

4. The mobile computing device of claim 3, wherein the first radiating aperture aligns with a first edge or surface of the mobile computing device.

5. The mobile computing device of claim 4, wherein the second radiating aperture aligns with a second edge or surface of the mobile computing device that is different from the first edge or surface.

6. The mobile computing device of claim 5, wherein the first edge or surface is normal to the second edge or surface.

7. The mobile computing device of claim 5, wherein the first edge or surface is parallel to the second edge or surface.

8. The mobile computing device of claim 7, wherein the plurality of antennas comprises a third antenna having a third radiating aperture that aligns with a third edge or surface of the mobile computing device that is different from both of the first edge or surface and the second edge or surface, and further wherein the third edge or surface is normal to both of the first edge or surface and the second edge or surface.

9. The mobile computing device of claim 1, wherein each of the plurality of antennas has a width of less than 0.5 millimeters (mm).

10. The mobile computing device of claim 1, wherein each of the plurality of antennas are shaped as a planar plate and the plurality of antennas are mounted in or on the mobile computing device within a same plane.

11. The mobile computing device of claim 1, wherein the reflector or lens comprises a plurality of GRIN lenses.

12. The mobile computing device of claim 11, wherein the plurality of GRIN lenses are positioned in series such that the first signal or the second signal passes through each of the plurality of GRIN lenses.

13. The mobile computing device of claim 11, wherein a first GRIN lens of the plurality of GRIN lenses is disposed inside a channel configured to serve as a waveguide for electromagnetic radiation, the first GRIN lens configured to receive electromagnetic radiation output from the antenna feed element.

14. The mobile computing device of claim 13, wherein a second GRIN lens of the plurality of GRIN lenses is disposed inside the channel and configured to receive the electromagnetic radiation output from the antenna feed element by way of the first GRIN lens.

15. The mobile computing device of claim 14, wherein first GRIN lens is a focal lens configured to squint a beam radiated from the antenna feed element toward the second GRIN lens.

16. The mobile computing device of claim 15, wherein the second GRIN lens is an aperture lens configured to output collimated beams from an output of the first GRIN lens.

17. The mobile computing device of claim 13, wherein the channel is formed by two parallel plates.

18. The mobile computing device of claim 1, wherein each one of plurality of antennas comprises multiple antenna feed elements.

19. A method comprising:
focusing, with a reflector or lens of a mobile computing device, a first signal not generated by an antenna feed element of the mobile computing device onto the antenna feed element;
controlling, by a controller or processor of the mobile computing device, the antenna feed element to generate a representation of the first signal, wherein the first signal has a nominal wavelength;
controlling, by the controller or processor of the mobile computing device, the antenna feed element to generate a second signal; and
focusing, with the reflector or lens, the second signal generated by the antenna feed element to emit the second signal.

20. An electromagnetic antenna of a mobile computing device comprising:
an antenna feed element configured to radiate a first signal, the first signal having a first frequency, a first amplitude, and a first phase;
a channel formed by two parallel plates spaced apart by a predetermined distance less than 1λ, wherein λ is a wavelength of the first signal emitted by the electromagnetic antenna, and the two parallel plates form a channel serving as a waveguide for electromagnetic radiation;
a planar focal surface on which the antenna feed element is mounted; and
an electromagnetic lens configured to focus the first signal for transmission,
wherein the electromagnetic lens comprises a compound lens having first and second lens elements arranged in series, wherein the compound lens focuses the first signal, and wherein each of the first and second lens elements comprises a gradient-index (GRIN) lens,
wherein an end of the channel from which the first signal is emitted comprises a radiating aperture of the electromagnetic antenna, wherein the radiating aperture is positioned along an edge of a surface of the mobile computing device.
